(19) United States
(12) Patent Application Publication
(10) Pub. No.: US 2021/0307492 A1
(43) Pub. Date: Oct. 7, 2021

(54) SMART-MIRROR DISPLAY SYSTEM

(71) Applicant: MAGICOM INC., Alpharetta, GA (US)

(72) Inventor: Hongjun Song, Alpharetta, GA (US)

(21) Appl. No.: 17/220,026

(22) Filed: Apr. 1, 2021

Related U.S. Application Data
(60) Provisional application No. 63/003,543, filed on Apr. 1, 2020.

(51) Int. Cl. A45D 42/16; G06T 7/73; G06F 3/01; G06T 19/00

(52) U.S. Cl. CPC A45D 42/16; G06T 7/73; G06T 2207/30201; G06T 19/006; G06F 3/011

(57) ABSTRACT

The present disclosure relates to a smart-mirror display system, and more specifically, to a display device that provides feedback regarding the application of cosmetics. The present disclosure further relates to the provision of cosmetic application data to interested parties such as, but not limited to, cosmetics manufacturers. In one aspect, the present disclosure provides a smart mirror system comprising: a display; and a processor communicative with the display, the processor operative to perform the following: receive a cosmetic profile, process the cosmetic profile, and output an image of a cosmetic applied to the face of a user in the display corresponding to the cosmetic profile.

### RELATED APPLICATION

The present application claims benefit under the provisions of 35 U.S.C. § 119(e) of U.S. Provisional Application No. 63/003,543 filed on Apr. 1, 2020, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### BACKGROUND

For an amateur, applying cosmetics using different techniques may be challenging. In many instances, a cosmetic user may be able to execute a cosmetic application technique, but they may not understand how or where to use the cosmetic technique properly to obtain a desired cosmetic style or “look”. Thus, a consumer may strive to apply their make up in a way that enhances their features in way that mimics their role model's features. This process may be difficult, iterative, and not lead the consumer to their desired results.

Furthermore, cosmetics manufacturers that supply the products to consumers rely on convention strategies to ensure they are able to develop, market, and deliver the right cosmetics products for the right consumers. For example, cosmetics manufacturers may rely on survey data to guide product development and sales strategies. Laboratory testing may also be incorporated in the process, to ensure the right properties of the cosmetics meet the characteristics of certain targeted consumers. However, many cosmetic manufacturers may still lack the right data to better serve their consumers in the application of their products.

Accordingly, there is a need to provide methods, systems, and devices that assist both consumers and cosmetics manufacturers in the development, marketing, delivery, and application of cosmetics products.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure relates to a smart-mirror display system, and more specifically, to a display device that provides feedback regarding the application of cosmetics. The present disclosure further relates to the provision of cosmetic application data to interested parties such as, but not limited to, cosmetics manufacturers.

A smart-mirror display system consistent with embodiments of the present disclosure may be used in, but not limited to, for example, beauty applications. The display system may incorporate leading edge technologies, including Internet of Things, (IoT), Argument Reality (AR) and Artificial Intelligence (AI), in the provision of methods and systems incorporating the display device (collectively referred to herein as a “display system”).

In various hardware embodiments, a smart-mirror display device may comprise a mirror body, mirror stand and mirror base. On or more lights and optical sensors may be distributed around the mirror body. In some embodiments, the lights and optical sensors may be embedded into a holder layer surrounding the mirror body. The distributed multiple lights may be configured to provide an enhanced view condition and bright field for beauty operation. In yet further embodiments, the plurality of lights may provide varying electromagnetic wave frequencies, and the optical sensors may be configured to capture a broad spectrum of electromagnetic wave frequencies, such that the optical sensors may detect various features of an end-user using the smart-mirror display device.

Still consistent with embodiments disclosed herein, multiple optical sensors (e.g., cameras) around the mirror body provide different view perspectives. In this way, the system of the present disclosure may generate a three-dimensional (3D) image of, for example, but not limited to, a human's face and/or body as it is displayed in the mirror. In various firmware and software embodiments, advanced 3D reconstruction techniques may be employed to receive images from multiple cameras and reconstruct 3D human models (including, but not limited to, a human's face and/or body) in real time.

The smart-mirror device consistent with embodiments of the present disclosure may comprise a computing device (e.g., a processing unit, memory storage, and communications module) for operating the plurality of electronics embedded in the device. Furthermore, via the communications module, the IoT device may connect to a hosted service, engaging the computing device in bi-directional communication between, the device, the end user, and the system provider. Furthermore, the system provide may, in turn, share the channel of communication or data relating thereto with third parties such as, for example, but not limited to, cosmetic manufacturers, advertisers, and e-commerce providers. In this way, the system may be enabled to provide customized beauty care services to its end users. In various embodiments, a software application operating on a remote device (e.g., a remote computing device such as a smartphone) may be configured to serve as part of bi-direction communication and control to interface with the smart-mirror device.

Embodiments of the mirror body may be composed of two layers: a first layer comprised of a mirror glass layer and a second layer comprised of a transparent display layer (e.g., an OLED layer). The display layer may be configured to display a user interface for interfacing the with the computing device. The display layer may provide an augmented reality (AR) rendering. Accordingly, the first mirror layer and the second mirror layer may align such that the user's reflection (e.g., the user's face) appears in the mirror overlaid by the AR rendering. In this way, the system of the present disclosure may provide, in one instance, a point-to-point comparison between the AR rendering and the end-user's reflection.

As will be evident, one such application is to enable an end-user to view an AR rendering of a model and enable a guided application of cosmetics on the user's face with the AR rendering overlaying the user's reflection. Accordingly, embodiments of the present disclosure provide advanced Al based techniques are developed and employed for real time beauty analysis and recommendation.

Embodiments of the present disclosure may provide for a plurality of user applications. In a first application, an end-user may use the system to envision an application of cosmetics on their visage employing the AR overlay. The AR overlay may provide, for example, a model having an appearance similar to the user. In turn, the user may apply cosmetics in attempts to match the appearance of the model. In a second application, the end-user may select which model the AR overlay should provide. In this way, the user can choose which model they would like to mimic in their cosmetics application. The selections of available models may be limited to, for example, those models whose facial structure matches the computed facial structure of the end-user when the end-user is within capturing range of the optical sensors. In a third application, the user may be trained, by the system, to apply cosmetics. As will be detailed below, training may comprise a simulation of make-up application in accordance to guidance provided through the AR overlay display.

In a fourth application, an interested party, such as, but not limited to, a cosmetics manufacture, can receive user data from the system. In various embodiments, the system may be configured to collecting user-images (via, for example, the optical sensors) and selected models associated with the end-user data. The data may be processed into related data. For example, the system can provide statistics, metrics, and anonymized data (extracting all personally identifiable information). The statistics can include, for example, what styles/models are the most popular for what type of user (e.g., demographics and segment of user). In turn, this data may be shared and used by, for example, cosmetics manufactures. In this way, the system may facilitate determinations of the popularity of styles, makeup type, models are popular, and share the data.

In a fifth application, the system may enable an administrative user or interested party to elect to follow or promote a user. The end-user may, in turn, become a sponsored model with followers. The end-user may provide, for example, instructional lessons that are viewable by other end-users using the smart-mirror device. In this way, embodiments of the present disclosure may enable a social-media application through the common use of the smart-mirror device and other applicable functionalities (e.g., smartphone application in remote operation with the smart-mirror device). The sponsorship methodology may include, for example, an interest parties promotion of the sponsored user with products and promotions (much like model sponsorship for corporate marketing purposes).

In a sixth application, the system may be used to enable users to purchase of the cosmetics products. The cosmetics may have been used by the end-user in, for example, an AR overlay training session or model mimicking session. Accordingly, in various embodiments, the system may be configured to provide an easy and convenient interface through which the end-user may purchase the cosmetics necessary to achieve a desired appears. For example, after seeing their face with make up to look like their favorite celebrity/model, the end-user may be enabled, through a user interface of the system, purchase the desired cosmetic products.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a front view of an example embodiment of a smart-mirror display system;

FIG. 2 illustrates a side view of the example embodiment smart-mirror display system;

FIG. 3 illustrates a flow diagram of an example method for operation of a smart-mirror display system;

FIG. 4 illustrates a flow diagram of an example method for operation of a smart-mirror display system;

FIG. 5 illustrates a flow diagram of an example method for operation of a smart-mirror display system;

FIG. 6 illustrates a flow diagram of an example method for operation of a smart-mirror display system;

FIG. 7 illustrates a flow diagram of an example method for operation of a smart-mirror display system;

FIG. 8 illustrates a flow diagram of an example method for operation of a smart-mirror display system; and

FIG. 9 illustrates a block diagram of a computing system operable with the smart-mirror display system.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of makeup application and cosmetics, embodiments of the present disclosure are not limited to use only in this context.

Consumers often apply cosmetics to achieve a particular style that includes particular colors, cosmetic types, and a set of application techniques in particular regions of the face of the cosmetic user.

Often, cosmetic users observe a person such as a fashion model or celebrity wearing cosmetics with a particular style. Such a user may desire to mimic the cosmetic style of the fashion model. However, identifying and applying the cosmetics that were used to create the desired style for the fashion model may be challenging for the user.

Even if a user is familiar with a variety of cosmetic application techniques, identifying the type of cosmetics to select or the particular colors of cosmetics to purchase poses a challenge for a cosmetic user.

Cosmetic users often apply cosmetics using a mirror to view portions of their face. Thus, it is desirable for a device to provide a substantially reflective surface, or the appearance of a substantially reflective surface, to allow the users to apply cosmetics using the reflective surface.

A cosmetic profile is a data set that describes a variety of factors related to a particular cosmetic style. A cosmetic profile may include, for example, a list of the cosmetics used to create the style, regions of the face to apply a particular cosmetic, and application techniques used to achieve the style.

Cosmetic manufacturers and retailers have an interest in identifying the types of cosmetics that a user uses and how the user uses their product. For example, though cosmetic manufacturers can collect sales data on their products, such sales data usually fails to describe how the user uses the product after purchase.

The description herein describes a display and vision system that assists a user in applying cosmetics. The system provides guidance to the user, and may provide feedback to an interested party such as cosmetic retailers or manufacturers.

Guidance may include any combination of video, images or textual and audible instructions that together provide quality instruction for applying a cosmetic to the face of a user.

Augmented reality (AR) may be used to superimpose, or paint virtual cosmetics on the face of the user who may view such augmentation on the display device. For example, AR may be used during guidance to superimpose a visual indication of where the user should apply a particular cosmetic as found in an associated cosmetic profile. Accordingly, a user may employ a user interface to select a desired cosmetic product (e.g., lipstick). Then, the user's motions may be tracked (e.g., the movement of the user's figure around their lips), and a corresponding cosmetic may be applied to the user's face in the AR superimposition. In other embodiments, the user may simply apply cosmetics to their face and the display device may provide visual feedback and queues as to the user's progress towards achieving a desired cosmetic appearance on their face.

The display device may be equipped for the internet of things (IoT) by connecting to a network such as the Internet or local network to interact with other systems. In addition to such features, the display device, may use artificial intelligence (AI) techniques to identify and determine the types, colors and techniques associated with the cosmetics of a user.

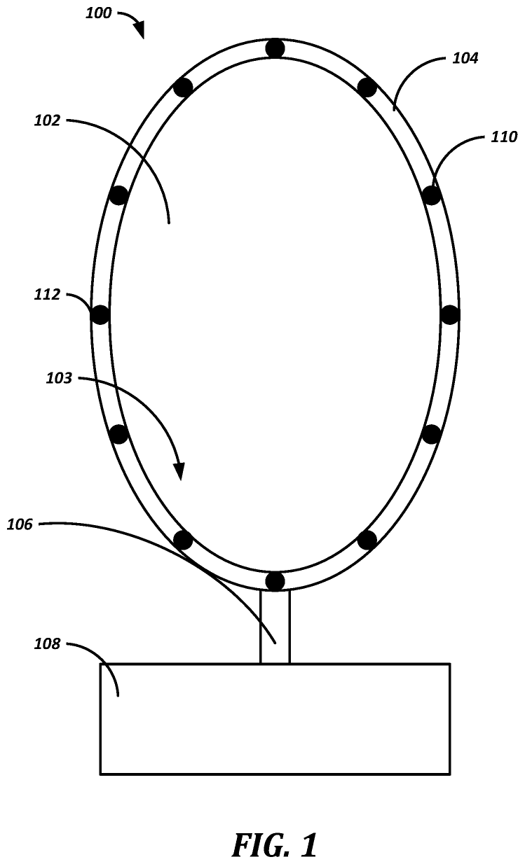

FIG. 1 illustrates a front view of an example embodiment of a smart-mirror display system 100. The smart-mirror display device (referred to herein as a ‘device’) 100 includes a display panel 102 having two layers. The display panel 102 in the illustrated example embodiment includes a substantially reflective surface 103 and a backing portion (described below). The display panel 102 provides a substantially reflective surface 103 that is operative to reflect the face of a user when the user is facing the display panel 102. The display panel 102 may include any number of materials, for example the reflective surface 103 may include a sheet of glass or a sheet of another material such as an acrylic or another suitably reflective material.

A frame 104 retains the display panel 102. In the illustrated example embodiment, the frame 104 is arranged on a stand 106 that is connected to the base 108, which supports the stand 106 and smart-mirror display system 100. The frame 104 may include any suitable material such as, for example, a metallic or plastic material. The frame 104 may also be formed from a natural material such as wood or a composite material.

The stand 106 is operative to support the frame 104 and the display panel 102. The frame 104 may be formed from, for example, a metallic or plastic material. In the illustrated example embodiment, the base 108 is shown supporting the stand 106. The stand 106 and base 108 may be formed from any suitable material, such as, for example, a metallic, plastic, or natural material.

The system 100 includes a plurality of cameras 110 and lights 112 that are arranged in positions around the frame 104. Such an arrangement is operative to illuminate a user facing the mirror and take one or more visual images or videos when the lights are operating. The lights 112 are arranged to offer enhanced viewing conditions and a bright field of view to assist in applying cosmetics and taking video or images of a user.

In this regard, any number of cameras 110 may be used to obtain a visual image of the user. Though, the cameras 110 shown in the illustrated example embodiment operate using a light input, any alternative type of suitable camera 110 may be used to capture images of the user. For example, an inferred system or other optical or sonic system may be used to gather data about the user. The images received by the cameras 110 provide for the use of three dimensional reconstruction techniques that capture images from a plurality of the cameras 110. Such a process displays a “live” AR image to the user with a depiction of a particular cosmetic style superimposed on the image of the user to present an approximation of how the user would look wearing a particular cosmetic style.

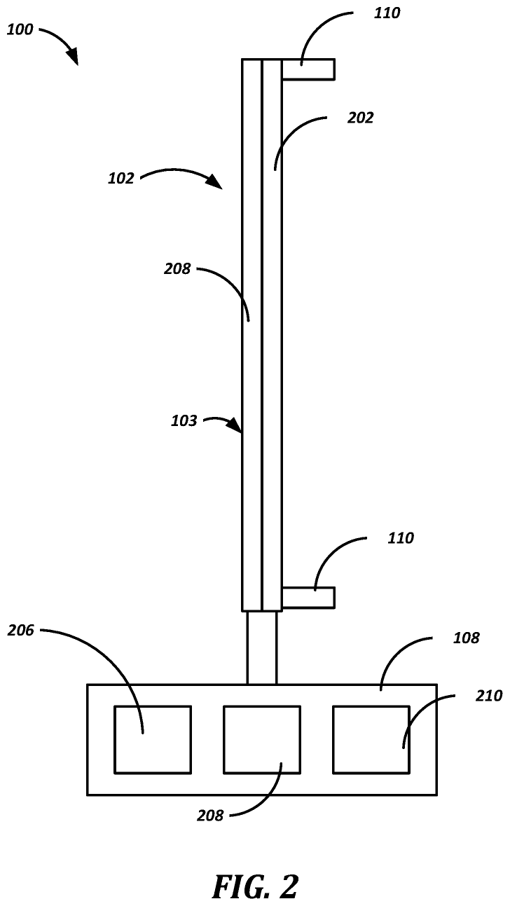

FIG. 2 illustrates a side view of the smart-mirror display system 100. The illustration shows the display 102 having a substantially transparent layer 208 and an electronic layer 202. In operation, the transparent layer 208 reflects an image of the user and may include a pane of glass or another suitable reflective arrangement. The electronic layer 202 displays an image of cosmetics superimposed on the reflected image of the user. Thus, when a user views the smart-mirror display system 100, the user may see the reflected image of themselves that also has indications on the face of the user for where to apply a cosmetic. In other example embodiments the user may see a reflected image of themselves that illustrates what they would look like with a particular cosmetic applied to their face.

The electronic layer 202 may include, for example, a transparent organic light emitting diode (OLED) a light emitting diode (LED), or any other suitable type of smart-mirror display system or process.

The multi-layered display 102 is operative to align with the reflected face to provide an augmented reality view and a point-to-point comparison between the user and a model wearing a particular cosmetic style.

In this regard, artificial intelligence techniques may be used to develop and employ substantially real-time cosmetic analysis and provide customized cosmetic care services.

The system 100 includes the base 108 that may retain the power supply 206, a processor 208 and a circuit board 210. The processor 208 of the system 100 is operative to control the operation of the system 100 by receiving data from a website, and account profile, a user, sensors, or a memory location and outputting images to the smart-mirror display system 100. Though the illustrated example embodiment includes a processor 208 and a smart-mirror display system 100 arranged in the base 108, the software operations of the system 100 may be, for example, performed remotely over a network or cloud-based service.

The processor 208 may also be used to send and receive data as an Internet of Things (IoT) system 100 such that the smart-mirror display system 100 may communicate, control, or be controlled by other connected systems.

The system 100 may also be used to identify cosmetics applied by the user and to identify how the user applies the cosmetics. Such information may be output to interested parties, and would allow retailers and manufacturers to better understand how their products are used.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules (local or remote computing device) disclosed herein. The methods may be embodied as, for example, but not limited to, computer instructions, which when executed, perform the methods disclosed herein.

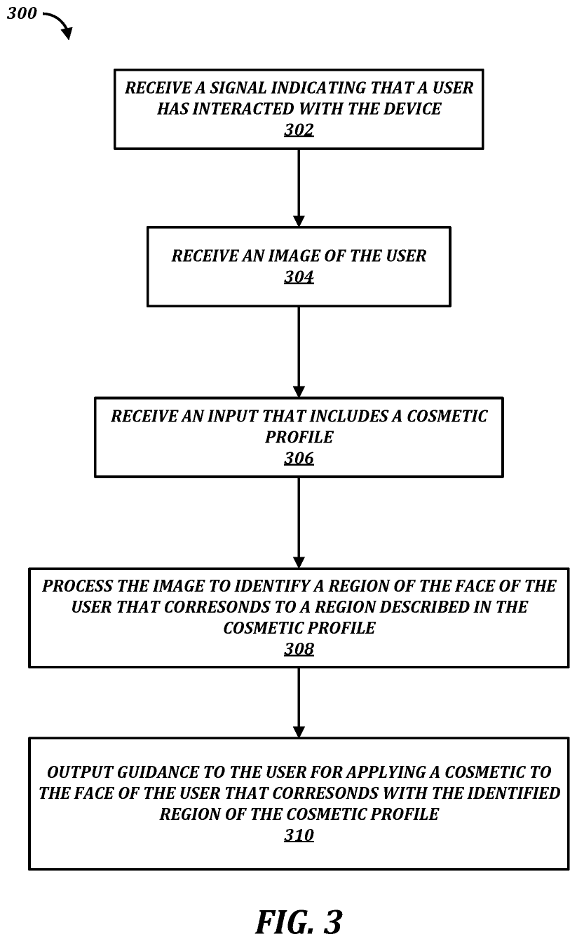

FIG. 3 illustrates a flow diagram of an example method 300 for operating a smart-mirror display system 100. In block 302, the processor 208 is operative to receive a signal indicating that a user has interacted with the system 100. Such a signal may be prompted by, for example, a camera 110 capturing the movement of a user, or another type of sensor arrangement such as a sensor that indicates when the user touches the system 100.

In block 304 an image of the user is received by the processor 208. The imaging process may, for example, include illuminating the user with lights 112 and taking multiple still images or moving images of the user with the cameras 110.

The system 100 receives cosmetic profile input. The cosmetic profile may include, for example, a description of the cosmetics described in the profile, and instructions for applying the cosmetic profile. The profile may also include data identifying where on the face the cosmetics are used and what application techniques should be used by the user to apply cosmetics according to the received cosmetic profile.

The profile may also include data and instructions to the system 100 to display cosmetic indicators on a region of the face. Cosmetic indicators include any suitable visual indicators such as, for example, graphical shape, lines, text, and color to indicate a region of the face of a user that should receive an application of a particular cosmetic. The indicators may include recommendations to the user to apply the cosmetic using a particular tool or technique.

The cosmetic indicators may be presented by the system 100 with the display 102 while the user faces the display 102 to result in an image that includes the reflected image of the use and the cosmetic indicators.

In some embodiments the image of the user may include a simulated mirror image. In this regard, the cameras 110 may be used to capture images of the user. The system 100 may display the images of the user on the display 102, while superimposing cosmetic indicators on the image of the user.

The received image is processed by the processor 208 (of FIG. 2) to identify a region of the face of the user that corresponds to a region described by the cosmetic profile in block 308.

Referring to block 310 in FIG. 3, guidance for applying a cosmetic to the face of the user is output to the user on the display 102. The guidance provided by the system 100 includes presenting a graphic, textual, and audio guidance to the user. The system 100 may present a reflected image of the face of a user and superimposed cosmetic indicator regions on the face of the user in the display 102. The superimposed cosmetic indicators are defined by the cosmetic profile. The cosmetic indicators and the profile may be used to identify the type of cosmetics, and where and how to apply the cosmetics.

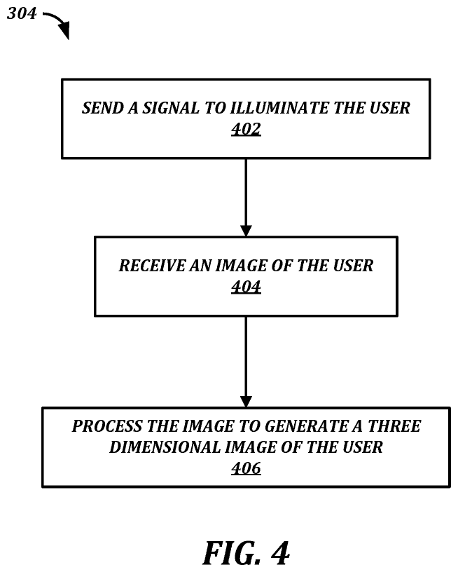

FIG. 4 Illustrates a block diagram of how the process in block 304 receives an image of a user. In this regard, in block 402, a signal is sent by the processor 208 to the lights to turn on and illuminate the user. In block 404 the processor 208 receives an image of the user from the cameras 110. In block 406, the system 100 processes the image to generate a three dimensional image of the user. Though the illustrated example embodiment includes the generation of a three dimensional image of the user, example embodiments may use two dimensional video or still images captured by the cameras 110 to perform the methods described herein.

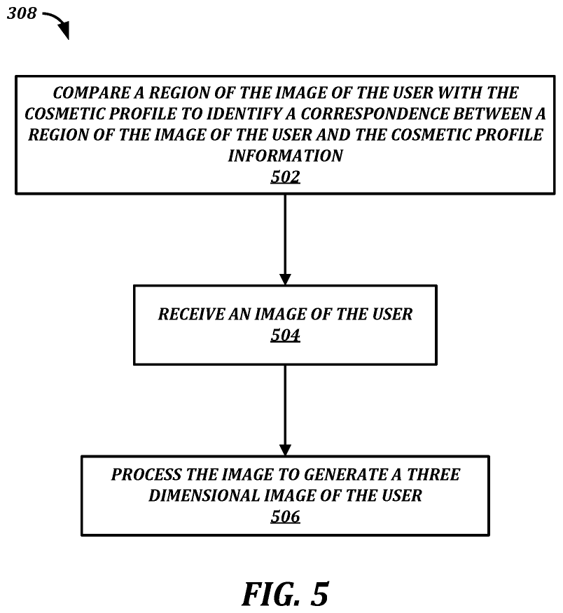

FIG. 5 illustrates a block diagram of an example method for performing the actions described in block 308 of FIG. 3. In block 502, the processor 208 is operative to compare a region of the image of the user with regions in the cosmetic profile to identify correspondence between regions of the image of the user and the cosmetic profile information.

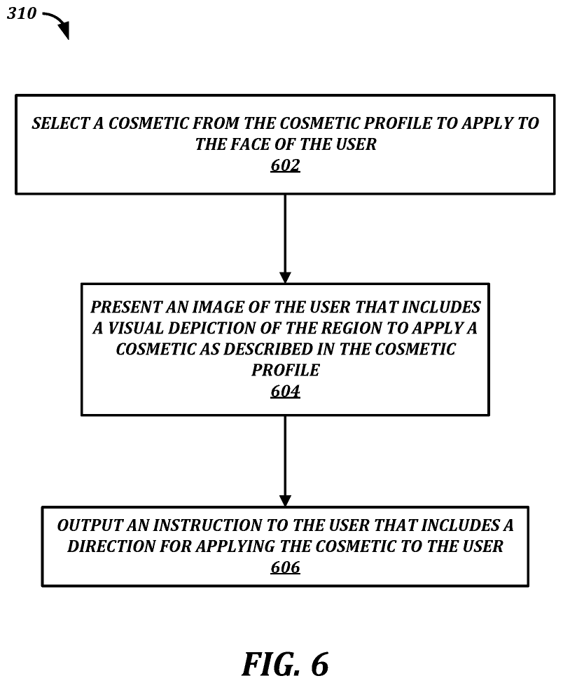

FIG. 6 illustrates a block diagram describing the block 310 (of FIG. 3) in more detail. In block 602 the processor 208 selects a cosmetic from the cosmetic profile to apply to the face of the user. The processor 208 outputs to the display an image of the user with a visual depiction of the region for applying the cosmetic arranged on the image of the user in block 604.

Block 606 includes outputting an instruction to the user that includes directions for applying the cosmetic to the user. Such instructions may include, for example, a particular cosmetic or color of a cosmetic for application and textual or graphical images displayed in the display 102 over the reflection of the user.

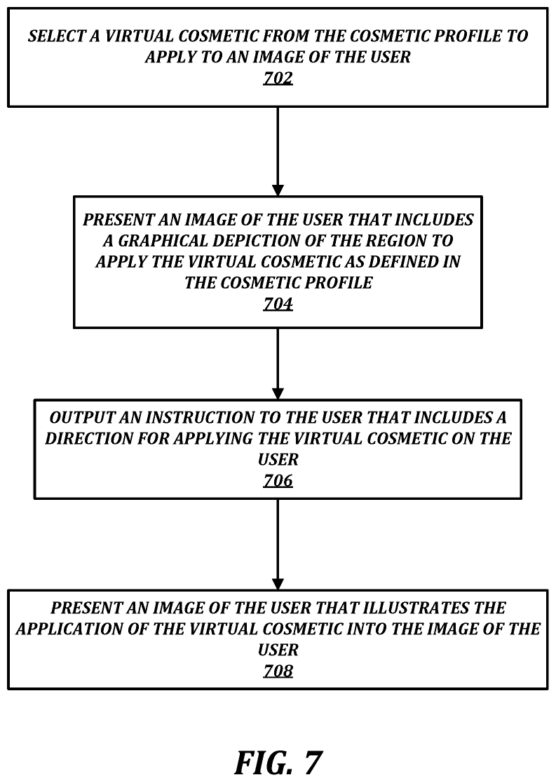

FIG. 7 illustrates a block diagram of another example method of operation for the system 100 (described above). In block 702, the system 100 may select a virtual cosmetic from the cosmetic profile to apply to the image of the user. The virtual cosmetic is generated by the superposition of a cosmetic image on the image of a user. The superposition of the image on the image of the user produces an effect that the user is wearing cosmetics when viewed in the display 102.

In block 704 the system 100 presents an image of the user that includes a graphical depiction of a region on the face of the user where the user should apply the virtual cosmetic. The region of the face may be found in the cosmetic profile.

For example, when a user operates the system 100 and the image of the user is displayed by the display 102, a virtual cosmetic such as lipstick having a particular color may be shown superimposed on the lips of a user in the display 102.

In block 706, the system 100 outputs an instruction to the user that includes direction for applying the virtual cosmetic on the user. In block 708, the system 100 presents an image of the user that illustrates the application of the virtual cosmetic into the image of the user.

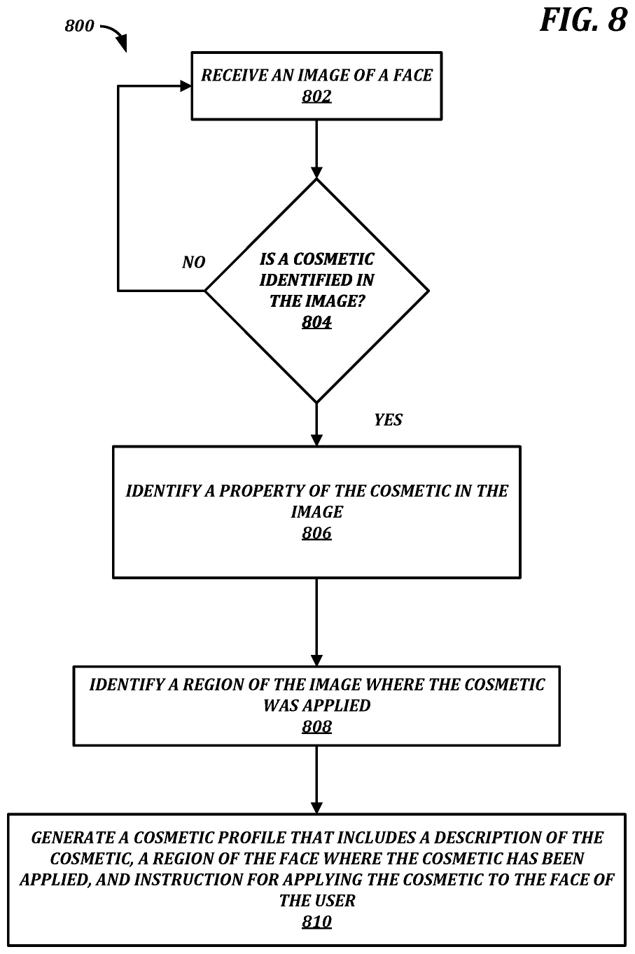

FIG. 8 illustrates a block diagram of a method for generating a cosmetic profile. In block 802 an image of a face is received by the system 100. The image may include an image of any face wearing cosmetics. In block 804, the system identifies whether cosmetics were applied to the face in the image. In block 806 the system identifies a property of the identified cosmetic of the image. A property may include, a color, type of cosmetic, consistency, materials, or any other identifiable properties. In block 808 the system 100 identifies a region of the image of the face where the cosmetic has been applied.

In block 810, the system 100 generates a cosmetic profile that includes a description of the cosmetic region of the face where in the cosmetic has been applied and instruction for applying the cosmetic to the face of the user.

Though the embodiments described herein include the system 100, some methods may be performed by other computing systems. For example, the method described in FIG. 8 may be performed using a computer processing system.

### Computing Device Architecture

The devices and systems of the present disclosure may be configured with a computing device 900. The computing device 900 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series; and
A microcomputer, wherein the microcomputer computing device comprises, but is not limited to, a server, wherein a server may be rack mounted, a workstation, an industrial device, a raspberry pi, a desktop, or an embedded device.

The system may be hosted on a centralized server or a cloud computing service. Although methods have been described to be performed by a computing device 900, it should be understood that, in some embodiments, different operations may be performed by a plurality of the computing devices 900 in operative communication at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for the purposes of redundancy, high availability, and/or performance. The combination of the presently disclosed units is configured to perform the stages any method disclosed herein.

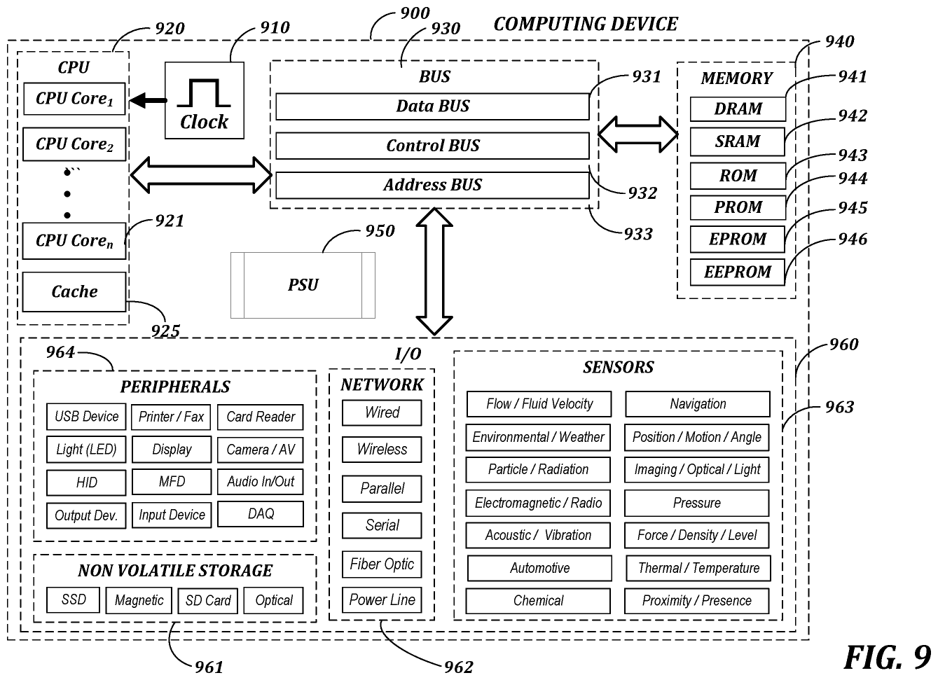

FIG. 9 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 9. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, the memory unit 940, consistent with embodiments of the disclosure.

At least one computing device 900 may be embodied as any of the computing elements illustrated in all of the attached figures, including [list the modules and methods]. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 9, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

A system consistent with an embodiment of the disclosure the computing device 900 may include the clock module 910 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 900 use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

A system consistent with an embodiment of the disclosure the computing device 900 may include the CPU unit 920 comprising at least one CPU Core 921. A plurality of CPU cores 921 may comprise identical the CPU cores 921, such as, but not limited to, homogeneous multi-core systems. It is also possible for the plurality of CPU cores 921 to comprise different the CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 at the same time. The CPU unit 920 may be integrated into at least one of a single integrated circuit die and multiple dies in a single chip package. The single integrated circuit die and multiple dies in a single chip package may contain a plurality of other aspects of the computing device 900, for example, but not limited to, the clock 910, the CPU 920, the bus 930, the memory 940, and I/O 960.

The CPU unit 920 may contain cache 922 such as, but not limited to, a level 1 cache, level 2 cache, level 3 cache or combination thereof. The aforementioned cache 922 may or may not be shared amongst a plurality of CPU cores 921. The cache 922 sharing comprises at least one of message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or external plurality of hardware and software components, for example, but not limited to a wire, optical fiber, communication protocols, and any physical arrangement that provides the same logical function as a parallel electrical bus. The bus 930 may comprise at least one of, but not limited to a parallel bus, wherein the parallel bus carry data words in parallel on multiple wires, and a serial bus, wherein the serial bus carry data in bit-serial form. The bus 930 may embody a plurality of topologies, for example, but not limited to, a multidrop/electrical parallel topology, a daisy chain topology, and a connected by switched hubs, such as USB bus. The bus 930 may comprise a plurality of embodiments, for example, but not limited to:
Internal data bus (data bus) 931/Memory bus.
Control bus 932.
Address bus 933.
System Management Bus (SMBus).
Front-Side-Bus (FSB).
External Bus Interface (EBI).
Local bus.
Expansion bus.
Lightning bus.
Controller Area Network (CAN bus).
Camera Link.
ExpressCard.
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS).
HyperTransport.
InfiniBand.
RapidIO.
Mobile Industry Processor Interface (MIPI).
Coherent Processor Interface (CAPI).
Plug-n-play.
1-Wire.
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.e., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U., and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI).
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 900 may employ hardware integrated circuits that store information for immediate use in the computing device 900, know to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher capacities at lower cost. The contents contained in memory 940, may be transferred to secondary storage via techniques such as, but not limited to, virtual memory and swap. The memory 940 may be associated with addressable semiconductor memory, such as integrated circuits consisting of silicon-based transistors, used for example as primary storage but also other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM).
Non-volatile memory which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system will be known to a person having ordinary skill in the art as I/O 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, human, environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using intermediate area in the memory 940. The non-volatile storage sub-module 961 does not lose data when power is removed and may be two orders of magnitude less costly than storage used in memory module, at the expense of speed and latency. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD−ROM/DVD−R/DVD+R/DVD−RW/DVD+RW/DVD±RW/DVD+R DL/DVD−RAM/HD−DVD), Blu-ray Disk (BD) (BD−/BD−R/BD−RE/BD−R DL/BD−RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory.
Holographic data storage such as Holographic Versatile Disk (HVD).
Molecular Memory.
Deoxyribonucleic Acid (DNA) digital data storage.

Consistent with the embodiments of the present disclosure, the aforementioned computing device 900 may employ the communication sub-module 962 as a subset of the I/O 960, which may be referred to by a person having ordinary skill in the art as at least one of, but not limited to, computer network, data network, and network. The network allows computing devices 900 to exchange data using connections, which may be known to a person having ordinary skill in the art as data links, between network nodes. The nodes comprise network computer devices 900 that originate, route, and terminate data. The nodes are identified by network addresses and can include a plurality of hosts consistent with the embodiments of a computing device 900. The aforementioned embodiments include, but not limited to personal computers, phones, servers, drones, and networking devices such as, but not limited to, hubs, switches, routers, modems, and firewalls.

Two nodes can be said are networked together, when one computing device 900 is able to exchange information with the other computing device 900, whether or not they have a direct connection with each other. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanism and organizational intent. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications.

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises at least one of the devices, modules, and subsystems whose purpose is to detect events or changes in its environment and send the information to the computing device 900. Sensors are sensitive to the measured property, are not sensitive to any property not measured, but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 900 may employ the peripherals sub-module 962 as a subset of the I/O 960. The peripheral sub-module 964 comprises ancillary devices uses to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 900. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 900 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices covert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 962 sub-module), data storage device (non-volatile storage 961), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### ASPECTS

The following disclose various Aspects of the present disclosure. The various Aspects are not to be construed as patent claims unless the language of the Aspect appears as a patent claim. The Aspects describe various non-limiting embodiments of the present disclosure.
A method:
   receive face
   3D model face
   compare face to celebrities/models
   recommend makeup/design based on celebrity appearance
      user can choose which celebrity they want to look like
Then:
   Can train people how to properly apply make up to their face to match the desired appearance
   All the while they are looking in the mirror
Application of make up
   System can Track finger on face, or
   System Track finger on mirror
   In this way, no actual make up required.
   User selects make up type
      User applies it to face (just regular finger)/or can use empty brunch
      User sees updates on the mirror, even though they are not actually putting on makeup on their face
      Or, the mirror can be a touch screen—and sees how the makeup is applied

Guidance and corrective instruction is provided.
AR and AI Engine
   Compare Different Brands
   Find the one appropriate for skin tones
   AI recommendation (after much machine learning and training)
IoT
   Cosmetic Company can get data on all 3D face models
   Cosmetic Company can select models/sponsor people
   User can purchase products
   Use can choose to share data
   In this way, the IOT device becomes like an Alexa and bring in the sphere of E-Commerce
   Innovative IoT device including multiple lights and camera around the mirror
   Distributed multiple lights give an enhanced view condition
   Cameras from different positions enable accurate 3d face reconstruction to provide more information for beauty analysis
   Innovative two layers (regular mirror layer and transparent OLED layer)
   Advanced software technique for real time 3d face/body reconstruction from multiple cameras
   Advanced AI algorithms for real time beauty analysis and recommendation
   Cloud-based service provide two way communications and customized beauty care service

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A smart mirror system comprising:
a display; and
a processor communicative with the display, the processor operative to perform the following:
receive a cosmetic profile,
process the cosmetic profile, and
output an image of a cosmetic applied to the face of a user in the display corresponding to the cosmetic profile.

2. The smart mirror system of claim 1, wherein the display comprises a plurality of layers.

3. The smart mirror system of claim 2, wherein the plurality of layers comprises the following:
a substantially transparent layer; and
an electronic layer.

4. The smart mirror system of claim 3, wherein the substantially transparent layer is configured to reflect an image of the user.

5. The smart mirror system of claim 4, wherein the electronic layer is configured to superimpose cosmetics on the image of the user.

6. The smart mirror system of claim 5, wherein the display is operative to align with the reflected image of the user.

7. The smart mirror system of claim 1, wherein the display is configured to provide at least one of the following between the user and a model wearing a particular cosmetic:
augmented reality view; and
point-to-point comparison.

8. The smart mirror system of claim 1, wherein the display is housed in a frame.

9. The smart mirror system of claim 1, wherein the display comprises a Graphical User Interface (GUI).

10. The smart mirror system of claim 8, wherein the frame is configured to house a plurality of cameras in operative communication with the processor.

11. A method for providing a cosmetic recommendation via a smart mirror system, the method comprising:
receiving an image of the user;
receiving an input including a profile;
processing the image to identify a region of the image of the user corresponding to a region described in the profile; and
outputting guidance to the user for applying at least one cosmetic to the region of the user corresponding with the identified region of the profile.

12. The method of claim 11, further comprising receiving a signal indicating a user has interacted with the smart mirror system.

13. The method of claim 12, further comprising activating a receiving capability in response to the signal.

14. The method of claim 11, wherein receiving the input including a profile comprises receiving a selection of the at least one cosmetic.

15. A method for presenting a virtual cosmetic illustration via a smart mirror system, the method comprising:
selecting a virtual cosmetic from a cosmetic profile;
presenting an image of a user;
presenting a direction for applying the virtual cosmetic on the user; and
presenting an image of the user illustrating the application of the virtual cosmetic onto the image of the user.

16. The method of claim 15, wherein selecting the virtual cosmetic comprises selecting the virtual cosmetic to apply to an image of a user.

17. The method of claim 15, wherein presenting a direction for applying the virtual cosmetic on the user comprises providing a graphical representation of the region to apply the virtual cosmetic as defined by the cosmetic profile.

18. The method of claim 15, wherein presenting the image of the user illustrating the application of the virtual cosmetic onto the image of the user comprises a superposition of a cosmetic image on the image of the user.

19. The method of claim 15, further comprising producing an effect that the user is wearing cosmetics when viewed in the smart mirror system.

20. The method of claim 15, wherein selecting the virtual cosmetic from the cosmetic profile comprises selecting via a graphical user interface (GUI) of a display of the smart mirror system.
